(19) United States
(12) Patent Application Publication
(10) Pub. No.: US 2022/0180275 A1
(43) Pub. Date: Jun. 9, 2022

(54) OPTIMIZED SAFETY STOCK ORDERING IN A MULTI-ECHELON DATA CENTER SUPPLY CHAIN

(71) Applicant: Microsoft Technology Licensing, LLC, Redmond, WA (US)

(72) Inventors: Mahshid Salemi PARIZI, Redmond, WA (US); Wuqin LIN, Redmond, WA (US); Arjun MUKHERJEE, Bellevue, WA (US)

(21) Appl. No.: 17/114,563

(22) Filed: Dec. 8, 2020

(51) Int. Cl. G06Q 10/06; G06Q 10/08; G06Q 30/02; G06Q 30/00; G06Q 30/06; G06F 8/65; G06F 9/455; G06N 7/00

(52) U.S. Cl. CPC G06Q 10/06315; G06Q 10/0875; G06Q 30/0202; G06Q 30/0185; G06Q 30/0633; G06F 2009/4557; G06F 8/65; G06F 9/45558; G06N 7/00; G06Q 30/0631; G06F 2009/45595; G06Q 10/06375

(57) ABSTRACT

In non-limiting examples of the present disclosure, systems, methods and devices for automating server orders and generating interactive server inventory insights are provided. An aggregate target service level for a data center may be determined. A number of server clusters needed to fulfill the target service level on a future date may be determined. Safety stock values corresponding to a buffer number of server clusters needed to account for supply and demand variability for the data center and for one or more upstream nodes in the supply chain may be determined. The safety stock values that correspond to the most cost-effective scenario that still meets the target service level may be determined. Server orders corresponding to that scenario may be automatically placed and interactive server inventory insights corresponding to one or more scenario iterations may be generated and surfaced.

### BACKGROUND

Large and small entities have increasingly moved their computing workloads to cloud service providers. Because of this, the cloud service providers are in a situation where they expect cloud computing demand at their regional data centers to increase month after month. To meet the increasing demand the cloud service providers must periodically order and install additional servers in the regional data centers. Additionally, to ensure that service level targets for cloud computing customers are met, and to account for variability in cloud demand growth, lead time in receiving orders, and sellable capacity, cloud service providers attempt to keep some safety stock (e.g., buffer quantity of servers) in the data centers. However, keeping excess safety stock in the data centers is quite costly compared to keeping safety stock upstream in the cloud computing supply chain.

It is with respect to this general technical environment that aspects of the present technology disclosed herein have been contemplated. Furthermore, although a general environment has been discussed, it should be understood that the examples described herein should not be limited to the general environment identified in the background.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter. Additional aspects, features, and/or advantages of examples will be set forth in part in the description which follows and, in part, will be apparent from the description or may be learned by practice of the disclosure.

Non-limiting examples of the present disclosure describe systems, methods and devices for performing automated server ordering actions and generating server inventory insights in a multi-echelon cloud supply chain. An inventory planning service may determine an amount of cloud demand that can be expected for one or more data centers on a future date. A determination may also be made as to the expected variance in the growth rate for each of the one or more data centers, which can be used to determine the likelihood of going above or below the expected cloud demand by a given amount for the future date. The inventory planning service may also make a determination as to an aggregate target service level for each of the one or more data centers. The inventory planning service may then make a determination as to an amount of safety stock to keep at each node in the cloud supply chain (e.g., component location, warehouse, data centers) to meet the aggregate target service level for the one or more data centers. However, because the aggregate target service level may be met by having different sets of safety stock, where each set corresponds to a safety stock distribution across various nodes in the supply chain, an optimization algorithm may be used to determine the optimal safety stock distribution with minimal cost. As such, the inventory planning service may determine the mean and variable lead times between nodes in the supply chain such that it can compute the optimal safety stock set for the supply chain to account for variability.

The inventory planning service may additionally process historical capacity data from before and after hardware, firmware and software updates to the one or more data centers, and determine an expected amount of sellable capacity that is available in each server or server cluster for the future date that is being planned for. Thus, for each safety stock distribution projection that is made, the inventory planning service may determine a number of compute units that are sellable for that future date based on the variability in sellable capacity and the updates that are likely to be made to the servers in the one or more data centers prior to that future date.

Once the determinations are made as to the cloud demand variables and the cloud supply variables, the inventory planning service may generate projections for different safety stock distributions that are expected to meet the aggregate target service level for the one or more data centers. Based on these projections, a determination may be made as to a most cost-effective amount of safety stock to keep at each node in the supply chain while also hitting the aggregate target service level for the one or more data centers up to and on the future date the calculations have been made for. The inventory planning service may generate and surface interactive insights related to these projections an automatically place server orders based on these projections.

### BRIEF DESCRIPTION OF THE DRAWINGS

Non-limiting and non-exhaustive examples are described with reference to the following figures:

FIG. 1 is a schematic diagram illustrating an example distributed computing environment for automating cloud computing supply chain orders and generating cloud computing supply chain insights.

FIG. 2 illustrates a simplified block diagram of a multi-echelon cloud computing supply chain and associated supply and demand variability included therein.

FIG. 3 is a schematic diagram illustrating an example distributed computing environment for determining projected inventory of a data center based on input historical data, variable lead time, and different safety stock buffer scenarios.

FIG. 4 is a schematic diagram illustrating an example distributed computing environment for determining mean demand for a data center, customer growth rate variability for a data center, and fraudulent growth rate variability for a data center.

FIG. 5 illustrates exemplary insights for a plurality of safety stock buffer scenarios in a multi-echelon cloud computing supply chain.

FIG. 6 is an exemplary method for automating server orders in a multi-echelon cloud supply chain.

FIG. 7A is an exemplary method for generating interactive data center insights.

FIG. 7B is an exemplary method for automating server orders in a multi-echelon cloud supply chain.

FIGS. 8 and 9 are simplified diagrams of a mobile computing device with which aspects of the disclosure may be practiced.

FIG. 10 is a block diagram illustrating example physical components of a computing device with which aspects of the disclosure may be practiced.

FIG. 11 is a simplified block diagram of a distributed computing system in which aspects of the present disclosure may be practiced.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The various embodiments and examples described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the claims.

Examples of the disclosure provide systems, methods, and devices for performing automated server ordering actions and generating server inventory insights in a multi-echelon cloud supply chain. As described herein, a multi-echelon cloud supply chain refers to a geographically distributed cloud supply chain that includes a plurality of geographically distinct server supply and server operation nodes. For example, a first node may comprise a component location that receives and assembles server components into fully assembled server racks, a second node may comprise a server warehouse that is supplied servers from the component location, and a third node may comprise a regional data center that is supplied servers from the server warehouse. The regional data center is the location where the servers are finally installed and where computing workloads are executed.

Server safety stock may be stored at any of the nodes in the supply chain to account for supply and demand variability in the supply chain and at the regional data centers. As used herein, “safety stock” at a regional data center refers to any excess number of servers or server clusters at the data center above a number of servers or server clusters that are needed to meet mean demand for the data center. Safety stock at a regional data center is also referred to herein as the “hot buffer” for the data center. As used herein, “safety stock” at a server warehouse refers to any number of servers or server clusters at the server warehouse. As used herein, “safety stock” at a component location refers to any number of not yet assembled (but components in hand) servers or server clusters at the component location, or fully assembled servers or server clusters at the component location.

An inventory planning service described herein may perform operations associated with determining how much safety stock to carry, and therefore order for, at each node in the cloud computing supply chain. That is, the inventory planning service may determine a most cost effective amount of safety stock to carry at regional data centers, a server warehouse that serves those regional data centers, and a component location that serves the server warehouse, while accounting for an aggregate target service level for the data centers, as well as variability in cloud supply factors and cloud demand factors.

To determine the most cost-effective amount of safety stock to carry at each node in the supply chain, the inventory planning service may make a plurality of calculations and projections. In some examples, one or more other services may provide some of the projections to the inventory planning service, which may then use the projections to make the determination as to the most cost-effective amount of safety stock to carry at each node in the supply chain. However, for ease of illustration and description the inventory planning service is primarily described herein as making those projections.

Assuming for sake of illustration, that there is a single data center served by a single server warehouse, served by a single component location, a determination may be made as to a mean growth rate for the data center. A determination may then be made as to an amount of cloud demand that can be expected for the data center on a future date. A determination may also be made as to the expected variance in the growth rate for the data center, which can be used to determine the likelihood of going above or below the expected cloud demand by a given amount for the future date.

The inventory planning service may make a determination as to an aggregate target service level for the data center. The aggregate target service level may be estimated by a function of the segmented target service level and the quantity (e.g., in virtual cores, in compute units, in Azure® compute units) of each segment. The inventory planning service may then make a determination as to an amount of safety stock to keep at each node in the supply chain to meet the aggregate target service level for the data center. However, the aggregate target service level may be met by having different sets of safety stock, where each set corresponds to a safety stock distribution across various nodes in the supply chain. An optimization algorithm may be used to determine the optimal safety stock distribution with minimal cost. Thus, the inventory planning service needs to determine the mean and variable lead times between nodes in the supply chain such that it can compute the optimal safety stock set for the supply chain to account for variability.

As used herein, “lead time” between a component supplier and a component location refers to a duration of time that it takes to receive a server component at the component location from the component supplier from the time it is ordered. As used herein, “lead time” between a component location and a server warehouse refers to a duration of time that it takes to receive a server, or server cluster, at the server warehouse from the component location from the time it is ordered. As used herein, “lead time” between a server warehouse and a regional data center refers to a duration of time that it takes to receive a server, or server cluster, at the regional data center from the server warehouse from the time it is ordered. In determining the lead times between supply chain nodes, the inventory planning service may take into account expected backorder values and/or variable backorder values at the server warehouse and the component location. For example, there may typically be an expected backorder of servers that a server warehouse is in the process of filling via one or more component locations. This value is variable and may be added to the lead time between the server warehouse and the component location and to the lead time between the server warehouse and the data center.

In addition to the server supply for a data center being affected by lead time, expected backorder, and variable backorder, it may also be affected by variability in sellable capacity. That is, the number of compute units (e.g., Azure® compute units) that a server has based on executing a first workload utilizing first software, first firmware, and first hardware, may fluctuate based on changes to any of those factors (e.g., a software update, a firmware update, a hardware update, a workload modification). Thus, the inventory planning service may process historical capacity data from before and after such updates were made to one or more data centers, and determine an expected amount of sellable capacity that is available in each server or server cluster for the future date that is being planned for. Thus, for each safety stock distribution ratio projection that is made (e.g., each projection corresponding to a different number of servers in the hot buffer), the inventory planning service may determine a number of compute units that are sellable for that future date based on the variability in sellable capacity and the updates that are likely to be made to the servers in the data center prior to that future date.

Once the determinations are made as to the cloud demand variables and the cloud supply variables as discussed above, the inventory planning service may generate projections for different safety stock distributions that are expected to meet the aggregate target service level for the data center. The inventory planning service may start with a safety stock of zero at the warehouse and generate projections based on some predefined upward bound at the warehouse. Based on these projections, a determination may be made as to a most cost-effective amount of safety stock to keep at each node in the supply chain while also hitting the aggregate target service level for the data center up to and on the future date that the calculations have been made for.

In some examples, the inventory planning service may automatically place server orders to meet the determined most cost-effective amount of safety stock at each supply chain node. In additional examples, the inventory planning service may generate interactive insights related to the projections and cause those interactive insights to be displayed or otherwise surfaced. The insights may be interacted with for ordering safety stock at one or more nodes in the supply chain. In some examples, the one or more data points may be interacted with and adjusted and the projections may be automatically updated based on those interactions and adjustments and displayed or otherwise surfaced.

The systems, methods, and devices described herein provide technical advantages for identifying and implementing cost-effective cloud supply chain inventory buffers. By intelligently identifying the most cost-effective amount of safety stock to keep in regional data centers, the mechanisms described herein greatly reduce memory and processing costs associated with operating unneeded server clusters that are unlikely to be utilized until a later date. Rather, the mechanisms described herein allow cloud providers to automatically order servers and server clusters and ship them to cloud supply chain nodes only when they are likely to be needed based on intelligently determined lead times between nodes, as well as intelligently determined cloud demand variables. An additional advantage is that additional servers are moved to the warehouses where they can be pooled for distribution to any of the regional data centers that are serviced by the corresponding warehouses, rather than having excess servers being installed and unused at the regional data centers. Thus, moving the safety stock back in the supply chain allows for a need-based approach to keeping a server buffer. The mechanisms described herein are also useful in that projected sellable cloud supply can be adjusted to account for sellable capacity variability based on analyzing historical data related to computing workload modifications, software updates, firmware updates, and hardware updates that are made to a data center.

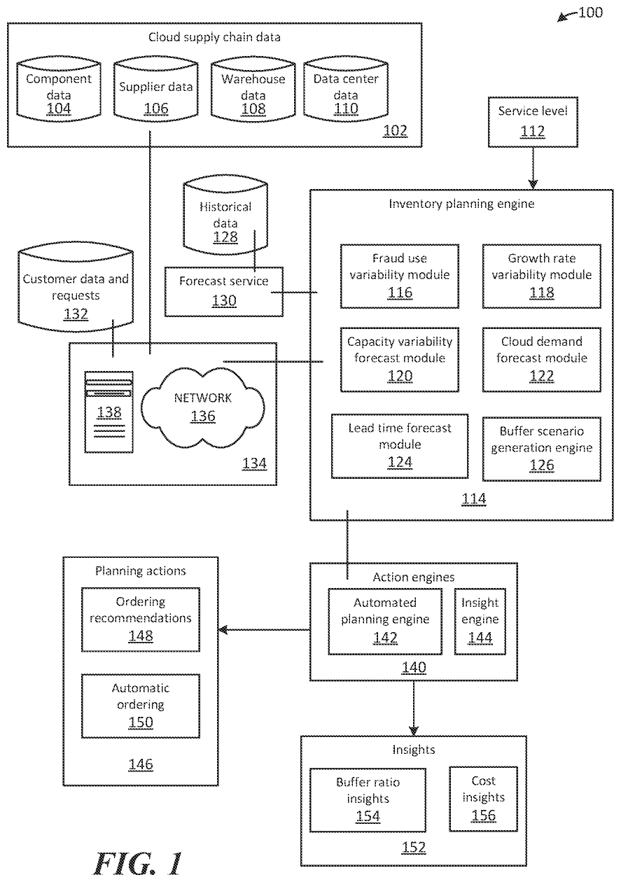

FIG. 1 is a schematic diagram illustrating an example distributed computing environment 100 for automating cloud computing supply chain orders and generating cloud computing supply chain insights. Computing environment 100 includes cloud supply chain data 102, service level 112, inventory planning engine 114, customer data and requests 132, historical data 128, forecast service 130, network and processing sub-environment 134, action engines 140, planning actions 146, and insights 152.

Cloud supply chain data 102 includes component data store 104, supplier data store 106, warehouse data store 108, and data center data store 110.

Component data store 104 may include data generated by or associated with a component entity (sometimes referred to herein as “component location”) in a multi-echelon cloud computing supply chain. The component entity may receive the individual components (e.g., hard drive, memory, fan) for servers that will eventually be installed in data centers, assemble those components into completed servers and server clusters, and store completed servers and server clusters prior to shipping them to server warehouses. Thus, component data store 104 may include identities of components that are utilized in building servers, geographic location data, duration of time it takes to receive components from component suppliers, duration of time it takes to assemble servers (e.g., from time of order), duration of time it takes to ship servers to server warehouses, transit time for server shipping, and cost to ship servers to server warehouses.

Supplier data store 106 may include data generated by or associated with hardware suppliers of server components in a multi-echelon cloud computing supply chain. The hardware suppliers may manufacture one or more server components and ship them to the component entity. Thus, supplier data store 106 may include identities of components the suppliers manufacture or sell, geographic location data, duration of time it takes to manufacture components (e.g., from time of order), duration of time it takes to ship components to component entities, transit time for component shipping, and cost to ship components to component entities.

Warehouse data store 108 may include data generated by or associated with a server warehouse in a multi-echelon cloud computing supply chain. The server warehouse may receive servers and server clusters from component entities, hold those servers until an order comes in from a regional data center, and ship servers to regional data centers upon receiving an order. Thus, warehouse data store 108 may include identities of server types that they have ordered from component entities, identities of server types that have been ordered by data centers, geographic location data, duration of time it takes to receive servers from component entities (e.g., from time of order), duration of time it takes to ship servers to regional data centers, transit time it takes to ship servers to regional data centers, and cost to ship servers to regional data centers.

Data center data store 110 may include data generated by or associated with a regional data centers in a multi-echelon cloud computing supply chain. The regional data centers may receive server clusters from server warehouses, install those servers, and host computing workloads for a variety of customers on those servers. Thus, data center data store 110 may include identities of server types that have been ordered from server warehouses and component entities, geographic location data, duration of time it takes to receive server clusters from server warehouses (e.g., from time of order), and cost to install and execute workloads on server clusters. Data center data store 110 may additionally include current and past customer workloads (e.g., number of virtual cores utilized by each customer, types of workloads handled by each server cluster or data center), types software updates that have been made to server clusters, types of firmware updates that have been made to server clusters, types of hardware updates that have been made to server clusters, growth rate of customer cloud usage, cloud demand backorder data, and fraudulent use of computing resources data.

Network and processing sub-environment 134 includes network 136 and server computing device 138. The computing devices described herein may communicate via a distributed computing network, such as network 136. Server computing device 138 is illustrative of one or more computing devices that may host one or more of the computing services and engines described herein, as well as the data that is processed by those computing services and engines. For example, one or more servers in network and processing sub-environment 134 may host inventory planning engine 114 and forecast service 130. Inventory planning engine 114 may be incorporated in an inventory planning service that is hosted in the cloud. One or more servers in network and processing sub-environment 134 may also host a cloud management platform that manages cloud computing customer requests and the corresponding computing workloads that are hosted in one or more regional data centers associated with a cloud computing provider. The cloud management platform may receive and maintain customer data and cloud computing requests for regional data centers of the cloud computing provider, as illustrated by customer data and requests store 132.

Each customer or customer type for a regional data center of a cloud computing provider may have a cloud computing service level associated with it. For example, a first customer, or customer type, may have a service level associated with it corresponding to a goal or requirement that 99% of the incoming cloud computing requests for that customer or customer type are served by the regional data center. Similarly, a second customer, or customer type, may have a service level associated with it corresponding to a goal or requirement that 95% of the incoming cloud computing requests for that customer or customer type are served by the regional data center.

The cloud management platform may determine an aggregate target service level for a regional data center. The aggregate target service level may correspond to a mean service level for a regional data center based on each of the workloads and service levels served by the regional data center. For example, if a first customer of a regional data center utilizes 100,000 virtual cores of the regional data center and has a target service level associated with it of 99%, and a second customer utilizes 100,000 virtual cores of the regional data center and has a target service level associated with it of 95%, while assuming these are the only two customers served by the regional data center, the aggregate target service level for that regional data center would be 97%. The aggregate target service level for each regional data center managed by the cloud management platform may be provided to inventory planning engine 114, as indicated by service level 112.

In other examples, the aggregate target service level may be determined via application of a newsvendor model to the individual customer target service level values. For example, the inventory planning service may estimate the margin benefit to marginal cost ratio for each segment—using the inverse of the newsvendor model, then weight average the ratio, and finally convert the aggregate ratio to the target service level—applying the newsvendor model.

Inventory planning engine 114 includes fraud use variability module 116, growth rate variability module 118, capacity variability forecast module 120, cloud demand forecast module 122, lead time forecast module 124, and buffer scenario generation engine 126. In some examples, one or more of the forecasts or variability determinations described herein as being determined by inventory planning engine 114 may be determined by a separate forecast service (e.g., forecast service 130). These forecasts and variability determinations may be made based on the processing of historical data from one or more echelons of a cloud supply chain, such as from component data store 104, supplier data store 106, warehouse data store 108, and data center data store 110. The data from those data stores may be provided to historical data store 128, for processing by forecast service 130 and/or inventory planning engine 114.

Fraud use variability module 116 may receive historical cloud use data for a regional data center, determine an amount of that cloud use (e.g., number of virtual cores per month, number of physical server units per week) that fraudulent use of the data center accounted for, and generate one or more projections corresponding to an amount of fraud use that can be expected at the regional data center on a future date or over a future span of time. In some examples, these projections may be made based on determining a fraud growth rate for the data center. Fraud use variability module 116 may project expected variances in fraud that may be expected at a regional data center, as well as a mean projection of fraud use for that regional data center.

Growth rate variability module 118 may receive historical cloud use data for a regional data center and determine an expected cloud demand growth rate for a future span of time for that regional data center. Growth rate variability module 118 may also determine a standard deviations from that expected cloud demand growth rate for the future span of time for that regional data center.

Capacity variability forecast module 120 may receive historical cloud use data for a regional data center, historical computing workload data for the data center, software update data for the data center, firmware update data for the data center, hardware update data for the data center, service level data for the data center, and backorder fill data for the data center, and determine an expected computing workload (e.g., in compute units, in terabytes per unit of time) that is expected to be able to be handled by each physical server unit, or server cluster, on a future date or over a future span of time. For example, a single server may be capable of processing 1.0 TB per unit of time of a computing workload for a customer prior to a software, firmware, or hardware update, and that same server may be capable of processing 1.1 TBs per unit of time of a computing workload for the customer after the software, firmware, or hardware update has been completed. This variability in the amount of workload processing that can be handled by same physical server units is determined by capacity variability forecast module 120.

Cloud demand forecast module 122 may receive historical cloud use data for a regional data center, determine an amount of that cloud use (e.g., number of virtual cores per month, number of physical server units per week) that customer use of the data center accounted for (e.g., excluding fraud), and generate one or more projections corresponding to an amount of customer use that can be expected at the regional data center on a future date or over a future span of time. Cloud demand forecast module 122 may forecast expected variances in customer cloud demand at the regional data center, as well as a mean projection of customer demand at the regional data center. Cloud demand forecast module 122 may make these determinations based on determined growth rate for a regional data center (e.g., based on determinations or forecasts made by growth rate variability module 118).

Lead time forecast module 124 may receive historical cloud supply chain data, which may include server order dates and duration of time needed to fill those orders, server component order dates and duration of time needed to fill those orders, duration of time to ship server components to component locations, duration of time to ship servers from component locations to regional warehouses, duration of time to ship servers from regional warehouses to regional data centers, and duration of time from receiving servers at regional data centers to the ability to process customer workloads on those servers at the regional data centers. Lead time forecast module 124 may determine a first lead time corresponding to a mean duration of time it takes from the ordering of server components from component suppliers to the receiving of those components at a component location (or until the completed assembly of those components into a server or server cluster). Lead time forecast module 124 may determine a second lead time corresponding to a mean duration of time it takes from the placement of an order for a server or server cluster from a server warehouse to a component location to receive that server or server cluster at the server warehouse. Lead time forecast module 124 may determine a third lead time corresponding to a mean duration of time it takes from the placement of an order for a server or server cluster from a regional data center to a server warehouse to receive and/or install that server or server cluster at the regional data center. In determining the lead times between supply chain nodes, lead time forecast module 124 may take into account expected backorder values and/or variable backorder values at the server warehouse and the component location. For example, there may typically be an expected backorder of servers that a server warehouse is in the process of filling via one or more component locations. This value is variable and may be added to the lead time between the server warehouse and the component location and to the lead time between the server warehouse and the data center. Lead time forecast module 124 may analyze historical data related to backorders and project expected backorders and variability in those expected backorders, and those projections may be incorporated in the lead times.

Buffer scenario generation engine 126 may receive outputs from one or more of forecast service 130, fraud use variability module 116, growth rate variability module 118, capacity variability forecast module 120, cloud demand forecast module 122, and lead time forecast module 124, and determine an amount of safety stock (e.g., servers, server clusters, server components) to keep at each echelon in a multi-echelon cloud computing supply chain to meet aggregate target service levels for one or more regional data centers, while also maintaining the lowest storage, energy, and shipping costs associated with meeting those aggregate service level demands. For example, buffer scenario generation engine 126 may make determinations based on an input future timeframe (e.g., three months out, six months out), as to how much safety stock to carry in each of the one or more regional data centers, how much safety stock to carry in the server warehouse that services those one or more regional data centers, and in some cases how much safety stock to carry in one or more component locations that service the server warehouse. These determinations may be made based on determining a most cost-effective server inventory scenario (e.g., how much safety stock is stored at each node in the multi-echelon cloud supply chain) such that the inventory position is greater than the demand expected over the lead time between the nodes while maintaining an aggregate target service level for the one or more regional data centers. These determinations take into account the mean lead time across the supply chain (including expected backorder), the variance in lead time across the supply chain (including variable backorder), the mean cloud demand on each regional data center, the variance in cloud demand on each regional data center, and the variance in supply (e.g., the amount of computing workload that can be handled by same physical server units based on software, firmware, and hardware updates, as well as workload modifications).

Action engines 140 includes automated planning engine 142 and insight engine 144. Action engines 140 may be included in inventory planning engine 114, or it may be part of a separate service. Automated planning engine 142 may generate or produce planning actions 146, which include ordering recommendations 148 and automatic ordering 150. Ordering recommendations 148 may include the surfacing of one or more recommendations, on a user interface, of when to order additional safety stock for one or more nodes in a multi-echelon cloud supply chain, as well as an amount (e.g., number of server units) of safety stock to order at those times to meet expected cloud demand over a future timeframe taking into account the lead time to obtain the safety stock, as well as the variables in the supply and demand chain. Automatic ordering 150 illustrates that upon determining a most cost effective inventory plan that meets the above-discussed supply and demand variables, action engines 140 may cause server and/or server component orders to be automatically placed to execute the most cost effective inventory plan. That is, action engines may place orders to place sufficient safety stock at each of the regional data centers, the server warehouses, and the component locations, to meet expected demand and service levels based on the lead time in the supply chain as well as the other supply and demand variables, while achieving the lowest possible cost to do so.

Insight engine 144 may generate insights 152, which includes buffer ratio insights 154 and cost insights 156. Buffer ratio insights 154 may comprise graphs, charts, or other visual aids that illustrate the different ratios of safety stock between nodes in a multi-echelon cloud supply chain that have been determined to be sufficient for meeting service level requirements or guarantees based on supply and demand variability in the cloud supply chain. These graphs, charts, or other visual aids may be interactive (e.g., a user may modify one or more values of a node in a graph or chart and see what effect that has on the ability to hit target service levels and/or how ordering and safety stock levels must be modified to hit target service levels). Cost insights 156 may comprise graphs, charts, or other visual aids that illustrate the different costs associated with the different ratios of safety stock between nodes in a multi echelon cloud supply chain that have been determined to be sufficient for meeting service level requirements or guarantees based on supply and demand variability in the cloud supply chain. Cost insights 156 may also be interactive in that a modification made to a buffer ratio insight 154 may impact one or more data points that are surfaced in cost insights 156, and that impact may be caused to be displayed in cost insights 156.

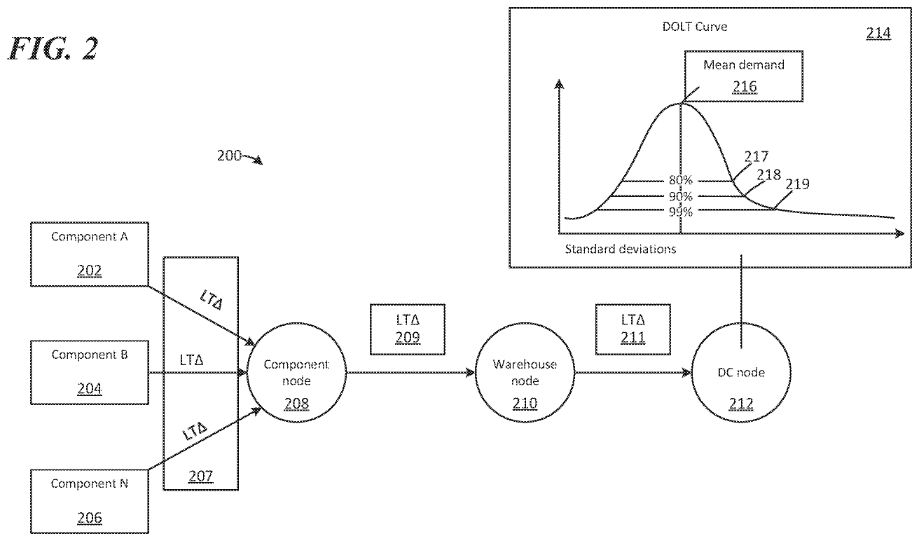

FIG. 2 illustrates a simplified block diagram 200 of a multi-echelon cloud computing supply chain and associated supply and demand variability included therein. Block diagram 200 includes data center node 212, warehouse node 210, component node 208, component A 202, component B 204, and component N 206. Block diagram 200 also includes demand over lead time (DOLT) curve graph 214.

Data center node 212 is illustrative of a regional data center in a multi-echelon cloud computing supply chain that is serviced by an upstream warehouse, represented here by warehouse node 210, and an upstream component location, represented here by component node 208. Component node 208 receives server components (e.g., hard drives, memory, processors, etc.) from various suppliers that are then assembled at component node 208 into completed servers and server clusters. The components are illustrated as component A 202, component B 204, and component N 206.

The inventory planning service may receive historical data corresponding to a duration of time that it takes to receive the components (e.g., component A 202, component B 204, component N 206) needed to assemble the servers at component node 208. This duration of time is illustrated by component lead times 207. The inventory planning service may then aggregate those times and determine a mean component lead time. The inventory planning service may additionally calculate component lead time variability based on the historical lead time data for the components.

The inventory planning service may also receive historical data corresponding to a duration of time that it takes to receive fully assembled servers and server clusters from component node 208 at warehouse node 210 after a request for servers is made. This duration of time is illustrated by warehouse lead time 209. The inventory planning service may determine a mean warehouse lead time and warehouse lead time variability based on this data.

The inventory planning service may additionally receive historical data corresponding to a duration of time that it takes to receive fully assembled servers and server clusters from warehouse node 210 at data center node 212 after a request for servers is made. This duration of time is illustrated by data center lead time 211. The inventory planning service may determine a mean data center lead time and data center lead time variability based on this data.

The inventory planning service may determine a mean demand for data center node 212 for a future date, which is illustrated by mean demand 216 in DOLT curve graph 214. This mean demand may be determined based on historical demand data (including customer workload data and fraudulent workload data), including historical growth rate data for the data center. The inventory planning service may additionally determine potential variability in that demand based on the historical demand data for the data center. This is illustrated by the standard deviation portions of DOLT curve graph 214, where the left side of mean demand 216 illustrates less demand in the variability projections, the right side of mean demand 216 illustrates more demand in the variability projections. In projecting the demand variability for data center node 212, the inventory planning service may determine potential fluctuations in the amount of sellable capacity in data center node 212 (e.g., based on past hardware updates, based on past software updates, based on past firmware updates, based on past workload variability).

Once the inventory planning service determines the expected lead time between each of the supply chain nodes, taking into account expected backorder values and variable backorder values, and the expected demand mean for the data center in addition to the demand variability for the data center, the inventory planning service may make determinations as to how much safety stock is necessary to hold at each supply chain node to meet service level targets for the data center customers. For example, based on maintaining a first variable value of servers at warehouse node 210, and a second variable value of servers (or server components) at component node 208, a third variable value of servers corresponding to first line 217 in DOLT curve graph 214 may be determined to be needed to maintain enough hot buffer at the data center to account for lead time variability and demand variability in order to maintain an 80% service level target for the data center. Similarly, based on maintaining the first variable value of servers at warehouse node 210, and the second variable value of servers (or server components) at component node 208, a fourth variable value of servers corresponding to second line 218 in DOLT curve graph 214 may be determined to be needed to maintain enough hot buffer at the data center to account for lead time variability and demand variability in order to maintain a 90% service level target for the data center. Additionally, based on maintaining the first variable value of servers at warehouse node 210, the second variable value of servers (or server components) at component node 208, a fifth variable value of servers corresponding to third line 219 in DOLT curve graph 214 may be determined to be needed to maintain enough hot buffer at the data center to account for lead time variability and demand variability in order to maintain a 99% service level target for the data center.

An adjustment of any of the variables (e.g., the safety stock at any of the nodes in the cloud supply chain) may result in a necessity to adjust safety stock values in the other nodes in order to hit target service levels. For example, if less safety stock is kept at warehouse node 210, more safety stock may be needed to be kept at data center node 212.

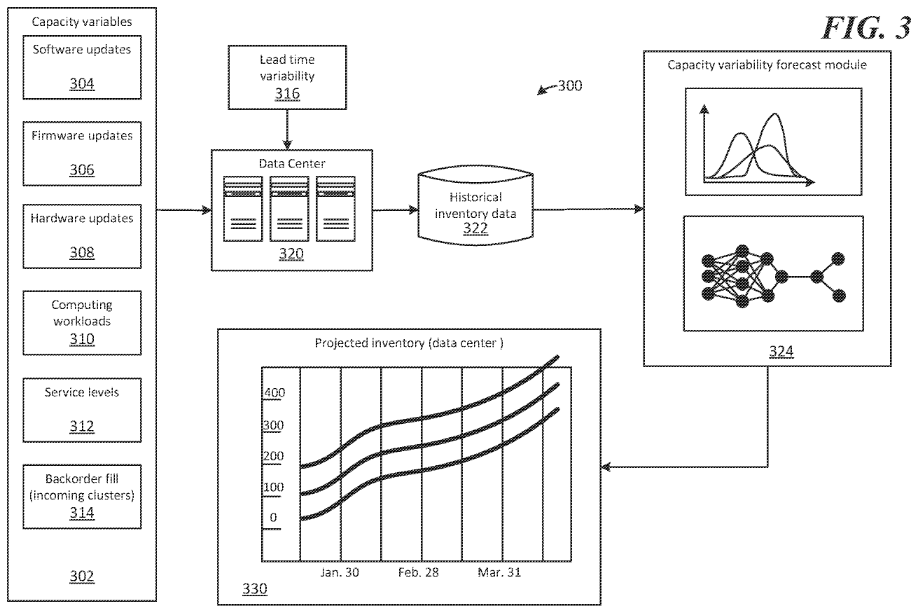

FIG. 3 is a schematic diagram illustrating an example distributed computing environment 300 for determining projected inventory of a data center 320 based on input historical data, variable lead time, and different safety stock buffer scenarios. Computing environment 300 includes capacity variables, data center 320, lead time variability element 316, historical inventory data store 322, capacity forecast module 324, and projected inventory graph 330.

Data center 320 represents a regional data center in a multi-echelon cloud supply chain that may be served by a server warehouse. Data for data center 320 may be saved to historical inventory data store 322. That data may include historical computing workload data, service level targets and actual target levels that were hit, new server requests, when requested servers were received from the warehouse that serves data center 320, number of servers or server clusters installed, and historical safety stock values.

Capacity variables 302 include software updates 304, firmware updates 306, hardware updates 308, computing workloads 310, service levels 312, and backorder fill (incoming clusters) 314. When software updates 304, firmware updates 306, hardware updates 308, or adjustments to computing workloads 310 or service levels 312 are made to data center 320, a number of physical servers or virtual cores that are needed to process computing workloads 310 before and after those updates and/or adjustments are made may be determined. That data may be stored in historical inventory data store 322 and processed by capacity variability forecast module 324 to determine the number of physical servers or virtual cores that are necessary to execute projected demand at an aggregate target service level for data center 320.

Lead time variability element 316 represents actual lead time fluctuation data that data center 320 received for server requests that were made to the server warehouse that serves it. That data may be stored in historical inventory data store 322 and processed by capacity variability forecast module 324 to determine a number of physical clusters that can be expected to be at data center 320 based on that historical lead time data and backorder fill (incoming clusters) 314 data.

Based on processing of historical inventory data 322, capacity variability forecast module 324 may determine a number of physical servers that may be expected to be operational in data center 320 on one or more future dates. In this example, capacity variability forecast module 324 has made three projections (represented by the three bold lines in projected inventory graph 330), where each of the three projections represents projected inventory in data center 320 based on a different combination of server warehouse safety stock to data center safety stock (e.g., hot buffer). For example, the lowest bolded line may correspond to a mean amount of inventory that is projected to be at data center 320 for hitting target service levels for projected demand based on maintaining the lowest amount of hot buffer in data center 320 while maintaining a highest amount of safety stock in the corresponding server warehouse. Alternatively, the highest bolded line may correspond to a mean amount of inventory that is projected to be at data center 320 for hitting target service levels for projected demand based on maintaining the highest amount of hot buffer in data center 320 while maintaining a lowest amount of safety stock in the corresponding server warehouse. Additionally, as described above, the physical number of servers needed to serve customer demand in data center 320 may fluctuate based on software updates 304, firmware updates 306, hardware updates 308, and modifications to computing workloads 310.

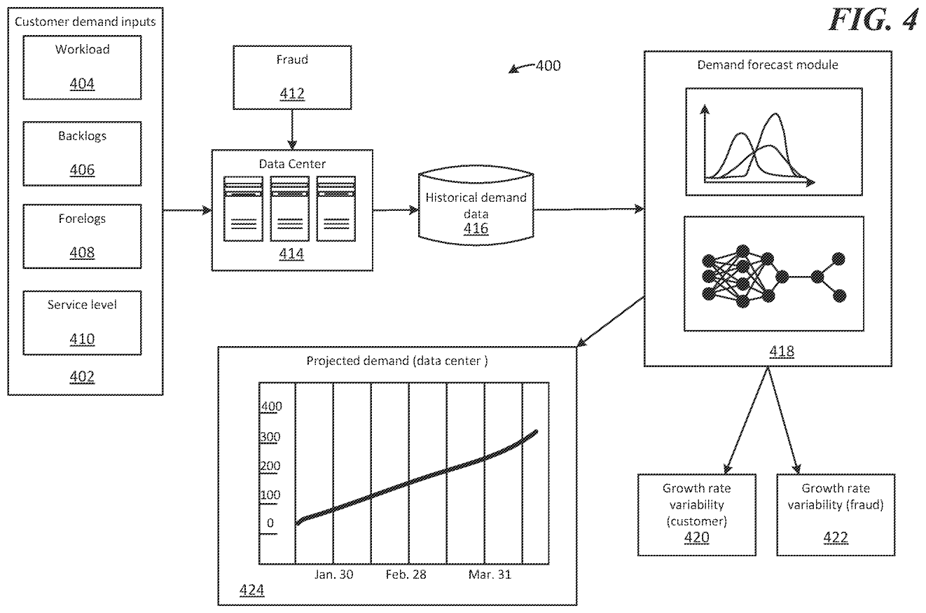

FIG. 4 is a schematic diagram illustrating an example distributed computing environment 402 for determining mean demand for a data center, customer growth rate variability for a data center, and fraudulent growth rate variability for a data center. Distributed computing environment 402 includes customer demand inputs, fraudulent demand input 412, data center 414, historical demand data store 416, demand forecast module 418, growth rate variability (customer) output 420, growth rate variability (fraud) output 422, and projected demand graph 424 for data center 414.

Data center 414 represents a regional data center in a multi-echelon cloud supply chain that may be served by a server warehouse. Customer demand inputs 402 includes customer workload data 404, customer backlogs data 406, customer forelogs data 408, and service level target data 410. Customer workload data 404 may include identities of customers served by data center 414, types of computing workloads handled for those customers, number of virtual cores that were needed to process computing workloads, number of servers that were needed to process computing workloads, and times and dates when requests for new workloads were received. Customer backlogs data 406 may include times and dates when workload requests were received and added to backlogs for data center 414, as well as when those backlogs were filled. Customer forelogs data 408 may include times and dates when requests for future workloads were received and times and dates when those requests were actually filled at data center 414. Service level target data 410 may include target service level percentages associated with customers served by data center 414 and actual service levels provided to those customers. Historical data corresponding to demand inputs 402 may be stored in historical demand data store 416.

Fraudulent demand input 412 represents computing demand on data center 414 from sources other than customers (e.g., users that are utilizing the resources of data center 414 without permission of the entity that manages data center 414). An amount of fraudulent demand (e.g., in virtual cores need to process, in number of physical servers needed to process, in compute units, in Azure® compute units) may be determined and stored in historical demand data store 416.

Demand forecast module may process the data in historical demand data store 416 and determine and generate growth rate variability (fraud) output 422, growth rate variability (customer) output 420, and projected demand graph 424. Projected demand graph 424 includes a bold line that represents the projected mean demand expected for future dates for data center 414 based on the historical demand data. Growth rate variability (customer) output 420 comprises projected growth rate variability in customer demand for data center 414 based on customer demand inputs 402. Growth rate variability (fraud) output 422 comprises projected growth rate variability in fraudulent demand for data center 414 based on fraudulent demand input 412.

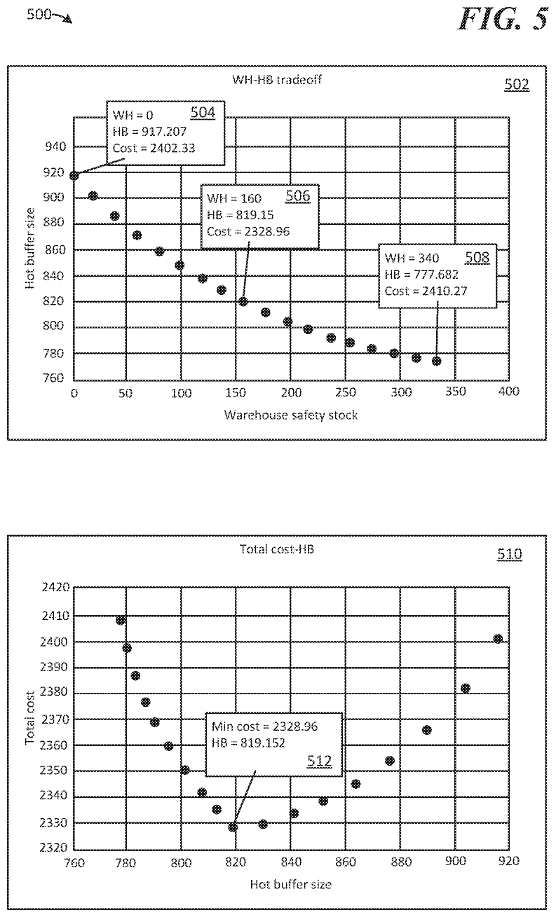

FIG. 5 illustrates exemplary insights 500 for a plurality of safety stock buffer scenarios in a multi-echelon cloud computing supply chain. Exemplary insights include first graph 502 and second graph 510. Although first graph 502 and second graph 510 are illustrative of two-echelon cloud supply chain safety stock ratios, it should be understood that similar graphs may be generated by the inventory planning service that take into account the third echelon (e.g., the component location) of the cloud supply chain. For example, three-dimensional graphs may be generated by the inventory planning service that include safety stock ratios between the component location, the server warehouse, and one or more data centers, which are projected to be sufficient to meet target service levels for the one or more data centers.

First graph 502 illustrates a plurality of buffer scenarios, where each scenario corresponds to a displayed data point on graph 502, and each scenario has a different ratio of safety stock (“hot buffer”) in one or more data centers compared with safety stock in a server warehouse that services those one or more data centers. In generating graph 502 the inventory planning service may have made determinations as to projected cloud demand for the one or more data centers on a future date, projected inventory (e.g., physical servers, virtual cores) on the future date, and an amount of inventory needed to meet aggregate target service levels based on variable inventory (e.g., taking into account lead time variability, taking into account physical server to workload processing variability) and variable cloud demand for the one or more data centers. Thus, each displayed data point corresponds to a ratio of data center safety stock to warehouse safety stock needed to meet the target service level at the future date that first graph 502 was generated for.

In generating an insight such as first graph 502 (e.g., a data center safety stock to warehouse safety stock insight), the inventory planning service may compute data center safety stock needed to meet aggregate target service levels for the one or more data centers at increments based on the warehouse safety stock starting at zero and incrementally increasing at each interval and data point. This safety stock scenario, with the warehouse safety stock being zero, is indicated at first data point 504, which includes a warehouse safety stock of 0 (e.g., 0 compute units), a hot buffer (e.g., data center safety stock) of 917.207 (e.g., 917,207 compute unties), and a cost for maintaining those safety stock ratios of 2402.33 (e.g., $24,023,300). The midpoint safety stock scenario, with the warehouse safety stock being 160, is indicated at ninth data point 506, which includes a warehouse safety stock of 160, a hot buffer of 819.15, and a cost of 2328.96. The highest warehouse buffer scenario, with the warehouse safety stock being 340, is indicated by eighteenth data point 508, which includes a warehouse safety stock of 340, a hot buffer of 777.682, and a cost of 2410.27.

According to some examples, when the inventory planning service generates and surfaces an insight such as graph 502, an interaction (e.g., a mouse click, a cursor hover, a touch input) with one of the data points may be received, which may cause the hot buffer to warehouse safety stock ratio for the interacted-with data point to be displayed, and/or the cost associated with that ratio to be displayed. In additional examples, if an interaction is received with one of the data points, a selectable user interface element may be surfaced on the insight for automatically ordering safety stock for the one or more data centers represented by the data point and the server warehouse at quantities corresponding to the ratio of the data point.

Second graph 510 illustrates the cost for implementing a plurality of safety stock ratios between one or more data centers and a server warehouse that services those one or more data centers, while meeting an aggregate target service level for those one or more data centers on a future date. As indicated on second graph 510, ninth data point 512, corresponding to a hot buffer of 819.152 has the lowest cost associated with it of all the safety stock scenarios. That cost is indicated as being 2328.96. As with first graph 502, when the inventory planning service generates insights such as graph 510, an interaction (e.g., a mouse click, a cursor hover, a touch input) with one of the data points may be received, which may cause the hot buffer to cost ratio for the interacted-with data point to be displayed. In additional examples, if an interaction is received with one of the data points, a selectable user interface may be surfaced on the insight (e.g., on second graph 510) for automatically ordering safety stock for the one or more data centers represented by the data point and the server warehouse at quantities corresponding to the ratio of the data point.

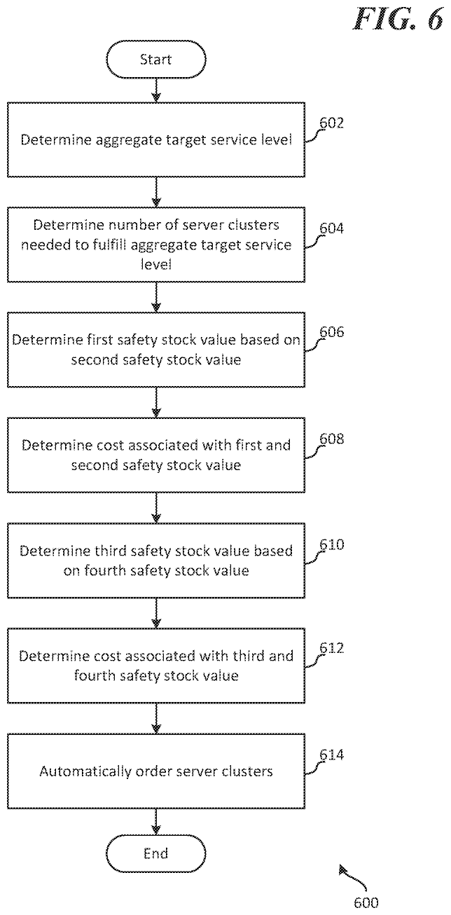

FIG. 6 is an exemplary method 600 for automating server orders in a multi-echelon cloud supply chain. The method 600 begins at a start operation and flow moves to operation 602.

At operation 602 an aggregate target service level for one or more data centers served by a server warehouse is determined. Each of the one or more data centers may process workloads for a plurality of customers. Each customer, or customer computing workload, may have a service level associated with it. For example, a first customer computing workload may have a 99% service level target associated with it. This means that the cloud service is targeting to process the first customer computing workload at the requested regional data center completely 99% of the time and 1% of the time some workload may need to be diverted to data center in other regions. Alternatively, a second customer computing workload may have a 95% service level target associated with it. This means that the cloud service is targeting to process that second customer computing workload at the requested regional data center completely 95% of the time and 5% of the time some workload may need to be diverted to data centers in other regions. In some examples, to determine the aggregate target service level, the inventory planning service may apply a newsvendor formula to the individual customer target service level values. For example, the inventory planning service may estimate the margin benefit to marginal cost ratio for each segment—using the inverse of the newsvendor formula, then weight average the ratio, and finally convert the aggregate ratio to the target service level—applying the newsvendor formula. Thus, the inventory planning service may determine a size of each computing workload and a target service level associated with each workload and from those values determine the aggregate target service level for the one or more data centers.

From operation 602 flow continues to operation 604 where a number of server clusters needed to fulfill the aggregate target service level on a future data is determined for each of the one or more data centers. In determining the number of server clusters needed to fulfill the aggregate target service level the inventory planning service may determine a mean demand growth rate for each of the data centers, as well as potential variance of that growth rate. Based on that determined demand growth rate, the inventory planning service may then determine a mean projected demand for the future date, in addition to potential variance (e.g., standard deviation) from that mean for the future date. Once these demand variables are determined for the future date, the number of compute units (e.g., Azure® compute units) that are needed to handle the projected demand on the date, accounting for potential variance, may be determined. The number of server clusters needed to process the determined number of compute units may fluctuate based on variable sellable capacity. That is, the number of compute units a server may process may change based on software updates, firmware updates, or hardware updates. The workload handled by a server may also affect the number of compute units it can process. Thus, the inventory planning service may process historical data center data for one or more regional data centers and make a projection as to how many compute units each server, or server cluster, will be able to process at the future date. Based on these computations the inventory planning service determines the number of server clusters needed to fulfill the aggregate target service level on the future date.

From operation 604 flow continues to operation 606 where a first safety stock value corresponding to a first buffer number of server clusters needed to account for supply variability and demand variability for the one or more data centers is determined for each of the one or more data centers for the future date. The determination is made based on a second safety stock value for the server warehouse corresponding to a second buffer number of server clusters in the server warehouse on the future date.

The supply variability may take into account the variable sellable capacity as discussed above in relation to operation 604. In addition, the inventory planning service may determine mean and variable lead times between each of the one or more data centers and the server warehouse. The lead time corresponds to a duration of time from the time a server order is placed by a data center to receive and install the corresponding server cluster in the data center (e.g., time from server order to installed server). The lead time may take into account expected backorder values and/or variable backorder values at the server warehouse and/or from one or more upstream component locations. For example, there may typically be an expected backorder of servers that a server warehouse is in the process of filling via one or more component locations. This value is variable and may be added to the lead time between each of the one or more data centers and the server warehouse, and/or the lead time between the server warehouse and each of the one or more component locations.

As to the first buffer number of server clusters needed to account for supply variability that is determined for each of the one or more data centers, that value is based on the second safety stock value for the server warehouse because the amount of safety stock (e.g., hot buffer) needed at a data center increases as the safety stock in the server warehouse decreases. Thus, the inventory planning service may compute the first buffer number of server clusters for each of the one or more data centers based on an input second safety stock value for the server warehouse, where the second safety stock value may be zero or more servers.

From operation 606 flow continues to operation 608 where a first cost associated with implementing server clusters corresponding to the first safety stock value and the second safety stock value is determined. The cost may be determined based on historical data, including historical shipping costs, historical warehouse storage costs, historical data center storage costs, and historical data center operation costs.

From operation 608 flow continues to operation 610 where a third safety stock value corresponding to a third buffer number of server clusters needed to account for supply variability and demand variability for the one or more data centers is determined for each of the one or more data centers for the future date. The determination is made based on a fourth safety stock value for the server warehouse corresponding to a fourth buffer number of server clusters in the server warehouse on the future date.

The supply variability may take into account the variable sellable capacity as discussed above in relation to operation 604. In addition, the inventory planning service may determine mean and variable lead times between each of the one or more data centers and the server warehouse. The lead time corresponds to a duration of time from the time a server order is placed by a data center to receive and install the corresponding server cluster in the data center (e.g., time from server order to installed server). The lead time may take into account expected backorder values and/or variable backorder values at the server warehouse and/or from one or more upstream component locations. For example, there may typically be an expected backorder of servers that a server warehouse is in the process of filling via one or more component locations. This value is variable and may be added to the lead time between each of the one or more data centers and the server warehouse, and/or the lead time between the server warehouse and each of the one or more component locations.

As to the third buffer number of server clusters needed to account for supply variability that is determined for each of the one or more data centers, that value is based on the fourth safety stock value for the server warehouse because the amount of safety stock (e.g., hot buffer) needed at a data center increases as the safety stock in the server warehouse decreases. Thus, the inventory planning service may compute the third buffer number of server clusters for each of the one or more data centers based on an input fourth safety stock value for the server warehouse, where the fourth safety stock value may be a zero or more servers and different from the second safety stock value.

From operation 610 flow continues to operation 612 where a second cost associated with implementing server clusters corresponding to the third safety stock value and the fourth safety stock value is determined. The cost may be determined based on historical data, including historical shipping costs, historical warehouse storage costs, historical data center storage costs, and historical data center operation costs.

From operation 612 flow continues to operation 614 where server clusters corresponding to the third safety stock value are automatically ordered for each of the one or more data centers based on the second cost being lower than the first cost. The server clusters may be automatically ordered by the inventory planning service.

From operation 614 flow moves to an end operation and the method 600 ends.

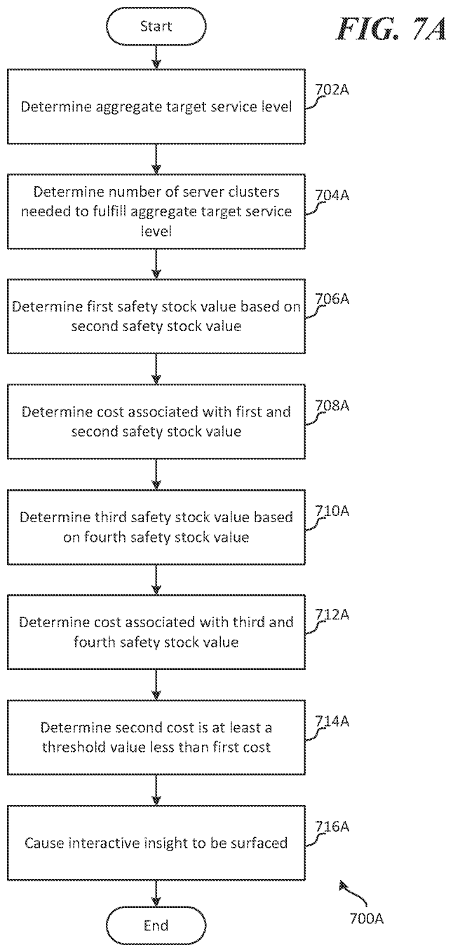

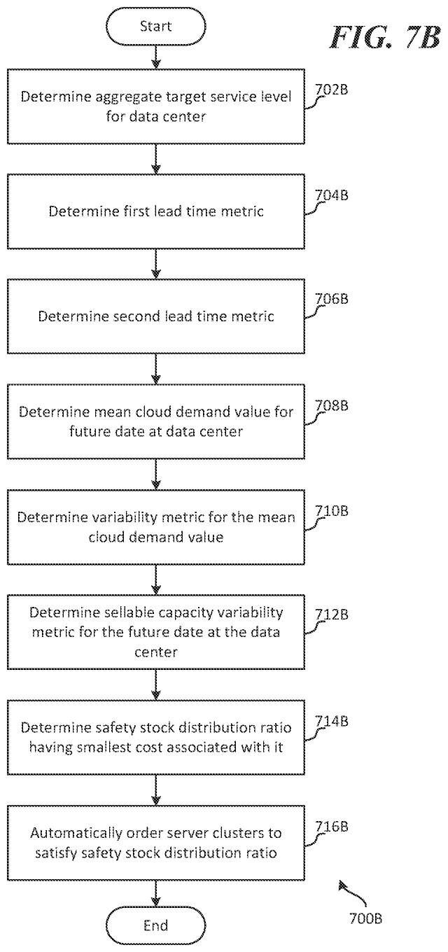

FIG. 7A is an exemplary method 700A for generating interactive data center insights. The method 700A begins at a start operation and flow moves to operation 702A.

At operation 702A an aggregate target service level for one or more data centers served by a server warehouse is determined. Each of the one or more data centers may process workloads for a plurality of customers. Each customer, or customer computing workload, may have a service level associated with it. For example, a first customer computing workload may have a 99% service level target associated with it. This means that the cloud service is targeting to process the first customer computing workload at the requested regional data center completely 99% of the time and 1% of the time some workload may need to be diverted to data center in other regions. Alternatively, a second customer computing workload may have a 95% service level target associated with it. This means that the cloud service is targeting to process that second customer computing workload at the requested regional data center completely 95% of the time and 5% of the time some workload may need to be diverted to data centers in other regions. In some examples, to determine the aggregate target service level, the inventory planning service may apply a newsvendor model to the individual customer target service level values. For example, the inventory planning service may estimate the margin benefit to marginal cost ratio for each segment—using the inverse of the newsvendor model, then weight average the ratio, and finally convert the aggregate ratio to the target service level—applying the newsvendor model. Thus, the inventory planning service may determine a size of each computing workload and a target service level associated with each workload and from those values determine the aggregate target service level for the one or more data centers.

From operation 702A flow continues to operation 704A where a number of server clusters needed to fulfill the aggregate target service level on a future data is determined for each of the one or more data centers. In determining the number of server clusters needed to fulfill the aggregate target service level the inventory planning service may determine a mean demand growth rate for each of the data centers, as well as potential variance of that growth rate. Based on that determined demand growth rate, the inventory planning service may then determine a mean projected demand for the future date, in addition to potential variance (e.g., standard deviation) from that mean for the future date. Once these demand variables are determined for the future date, the number of compute units (e.g., Azure® compute units) that are needed to handle the projected demand on the date, accounting for potential variance, may be determined. The number of server clusters needed to process the determined number of compute units may fluctuate based on variable sellable capacity. That is, the number of compute units a server may process may change based on software updates, firmware updates, or hardware updates. The workload handled by a server may also affect the number of compute units it can process. Thus, the inventory planning service may process historical data center data for one or more regional data centers and make a projection as to how many compute units each server, or server cluster, will be able to process at the future date. Based on these computations the inventory planning service determines the number of server clusters needed to fulfill the aggregate target service level on the future date.

From operation 704A flow continues to operation 706A where a first safety stock value corresponding to a first buffer number of server clusters needed to account for supply variability and demand variability for the one or more data centers is determined for each of the one or more data centers for the future date. The determination is made based on a second safety stock value for the server warehouse corresponding to a second buffer number of server clusters in the server warehouse on the future date.

The supply variability may take into account the variable sellable capacity as discussed above in relation to operation 704A. In addition, the inventory planning service may determine mean and variable lead times between each of the one or more data centers and the server warehouse. The lead time corresponds to a duration of time from the time a server order is placed by a data center to receive and install the corresponding server cluster in the data center (e.g., time from server order to installed server). The lead time may take into account expected backorder values and/or variable backorder values at the server warehouse and/or from one or more upstream component locations. For example, there may typically be an expected backorder of servers that a server warehouse is in the process of filling via one or more component locations. This value is variable and may be added to the lead time between each of the one or more data centers and the server warehouse, and/or the lead time between the server warehouse and each of the one or more component locations.

As to the first buffer number of server clusters needed to account for supply variability that is determined for each of the one or more data centers, that value is based on the second safety stock value for the server warehouse because the amount of safety stock (e.g., hot buffer) needed at a data center increases as the safety stock in the server warehouse decreases. Thus, the inventory planning service may compute the first buffer number of server clusters for each of the one or more data centers based on an input second safety stock value for the server warehouse, where the second safety stock value may be zero or more servers.

From operation 706A flow continues to operation 708A where a first cost associated with implementing server clusters corresponding to the first safety stock value and the second safety stock value is determined. The cost may be determined based historical data, including historical shipping costs, historical warehouse storage costs, historical data center storage costs, and historical data center operation costs.

From operation 708A flow continues to operation 710A where a third safety stock value corresponding to a third buffer number of server clusters needed to account for supply variability and demand variability for the one or more data centers is determined for each of the one or more data centers for the future date. The determination is made based on a fourth safety stock value for the server warehouse corresponding to a fourth buffer number of server clusters in the server warehouse on the future date.

The supply variability may take into account the variable sellable capacity as discussed above in relation to operation 704A. In addition, the inventory planning service may determine mean and variable lead times between each of the one or more data centers and the server warehouse. The lead time corresponds to a duration of time from the time a server order is placed by a data center to receive and install the corresponding server cluster in the data center (e.g., time from server order to installed server). The lead time may take into account expected backorder values and/or variable backorder values at the server warehouse and/or from one or more upstream component locations. For example, there may typically be an expected backorder of servers that a server warehouse is in the process of filling via one or more component locations. This value is variable and may be added to the lead time between each of the one or more data centers and the server warehouse, and/or the lead time between the server warehouse and each of the one or more component locations.

As to the third buffer number of server clusters needed to account for supply variability that is determined for each of the one or more data centers, that value is based on the fourth safety stock value for the server warehouse because the amount of safety stock (e.g., hot buffer) needed at a data center increases as the safety stock in the server warehouse decreases. Thus, the inventory planning service may compute the third buffer number of server clusters for each of the one or more data centers based on an input fourth safety stock value for the server warehouse, where the fourth safety stock value may be a zero or more servers and different from the second safety stock value.

From operation 710A flow continues to operation 712A where a second cost associated with implementing server clusters corresponding to the third safety stock value and the fourth safety stock value is determined. The cost may be determined based on historical data, including historical shipping costs, historical warehouse storage costs, historical data center storage costs, and historical data center operation costs.

From operation 712A flow continues to operation 714A where a determination is made that the second cost is at least a threshold value less than the first cost. The threshold value may be a monetary value (e.g., 1000, 10,000) or the threshold value may be a percentage.

From operation 714A flow continues to operation 716A where an interactive data center insight is caused to be surfaced based on determining that the second cost is at least the threshold value less than the first cost. The interactive data center insight may include a selectable option to place an order, over a distributed computing network, for server clusters corresponding to the third safety stock value for each of the one or more data centers.

From operation 716A flow continues to an end operation and the method 700A ends.

FIG. 7B is an exemplary method for automating server orders in a multi-echelon cloud supply chain. The method 700B begins at a start operation and flow moves to operation 702B.

At operation 702B an aggregate target service level for a data center served by a server warehouse is determined. The data center may process workloads for a plurality of customers. Each customer, or customer computing workload, may have a service level associated with it. For example, a first customer computing workload may have a 99% service level target associated with it. This means that the cloud service is targeting to process the first customer computing workload at the requested regional data center completely 99% of the time and 1% of the time some workload may need to be diverted to data center in other regions. Alternatively, a second customer computing workload may have a 95% service level target associated with it. This means that the cloud service is targeting to process that second customer computing workload at the requested regional data center completely 95% of the time and 5% of the time some workload may need to be diverted to data centers in other regions. In some examples, to determine the aggregate target service level, the inventory planning service may apply a newsvendor formula to the individual customer target service level values. For example, the inventory planning service may estimate the margin benefit to marginal cost ratio for each segment—using the inverse of the newsvendor formula, then weight average the ratio, and finally convert the aggregate ratio to the target service level—applying the newsvendor formula. Thus, the inventory planning service may determine a size of each computing workload and a target service level associated with each workload and from those values determine the aggregate target service level for the one or more data centers.

From operation 702B flow continues to operation 704B where a first lead time metric is determined. The first lead time metric may be determined by calculating a first mean lead time value between a component location and the server warehouse and calculating a first lead time variability value between the component location and the server warehouse. The first mean lead time value and the first lead time variability value may be determined based on processing historical order and shipping data for servers ordered from the component location for the server warehouse.

From operation 704B flow continues to operation 706B where a second lead time metric is determined. The second lead time metric may be determined by calculating a second mean lead time value between the server warehouse and the data center and calculating a second lead time variability value between the server warehouse and the data center. The second mean lead time value and the first lead time variability value may be determined by processing historical order and shipping data for servers ordered from the server warehouse for the data center.

From operation 706B flow continues to operation 708B where a mean cloud demand value for a future date at the data center is determined. The mean cloud demand value may be determined by processing historical cloud demand data for the data center. In some examples, the mean cloud demand value may be determined by determining a cloud demand growth rate associated with the data center.

From operation 708B flow continues to operation 710B where a variability metric for the mean cloud demand value for the future date at the data center is determined. The variability metric for the mean cloud demand value may be determined from the historical cloud demand data for the data center, including historical cloud demand growth rate data for the data center. In some examples, the variability metric for the mean cloud demand value may comprise a standard deviation metric.

From operation 710B flow continues to operation 712B where a sellable capacity variability metric corresponding to fluctuation in a number of compute units available in servers of the data center is determined for the future date at the data center. The sellable capacity variability metric may be determined from analyzing historical data from the data center corresponding to a number of compute units that were available before software, firmware, and/or hardware updates were made to servers in the data center, and after those updates were made.

From operation 712B flow continues to operation 714B where a safety stock distribution having a smallest cost associated with it is determined. The safety stock distribution ratio may correspond to a buffer number of server clusters to be kept in the data center, at the server warehouse, and at the component location, to account for the first lead time metric, the second lead time metric, the mean cloud demand value, the variability metric, the sellable capacity variability metric, and the aggregate target service level for the data center.

From operation 714B flow continues to operation 716B where servers are automatically ordered to satisfy the safety stock distribution.

From operation 716B flow moves to an end operation and the method 700B ends.

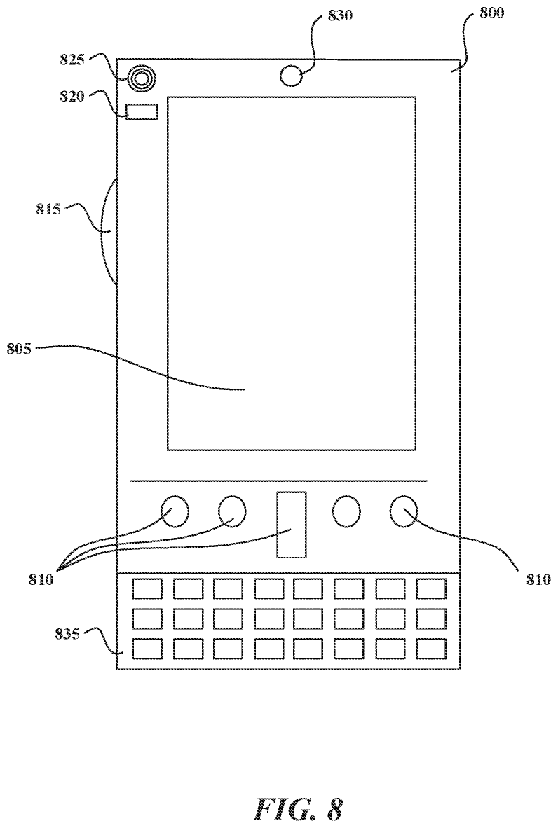

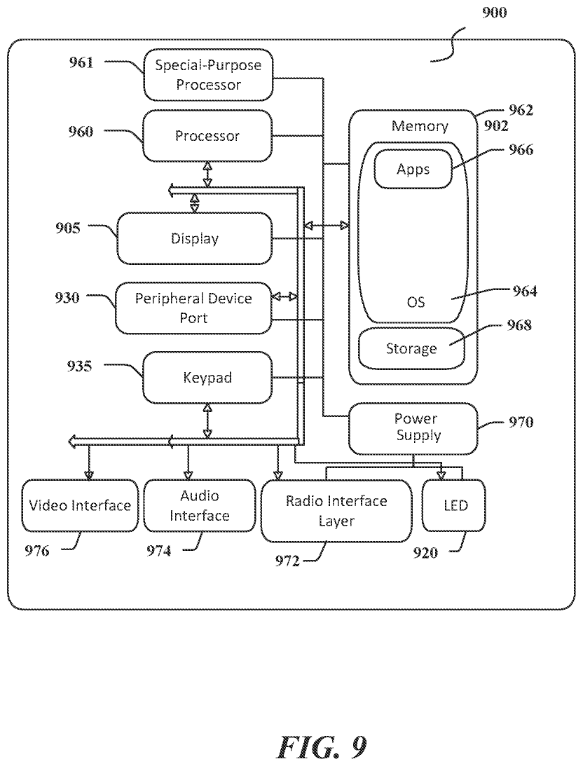

FIGS. 8 and 9 illustrate a mobile computing device 800, for example, a mobile telephone, a smart phone, wearable computer (such as smart eyeglasses), a tablet computer, an e-reader, a laptop computer, or other AR compatible computing device, with which embodiments of the disclosure may be practiced. With reference to FIG. 8, one aspect of a mobile computing device 800 for implementing the aspects is illustrated. In a basic configuration, the mobile computing device 800 is a handheld computer having both input elements and output elements. The mobile computing device 800 typically includes a display 805 and one or more input buttons 810 that allow the user to enter information into the mobile computing device 800. The display 805 of the mobile computing device 800 may also function as an input device (e.g., a touch screen display). If included, an optional side input element 815 allows further user input. The side input element 815 may be a rotary switch, a button, or any other type of manual input element. In alternative aspects, mobile computing device 800 may incorporate more or fewer input elements. For example, the display 805 may not be a touch screen in some embodiments. In yet another alternative embodiment, the mobile computing device 800 is a portable phone system, such as a cellular phone. The mobile computing device 800 may also include an optional keypad 835. Optional keypad 835 may be a physical keypad or a “soft” keypad generated on the touch screen display. In various embodiments, the output elements include the display 805 for showing a graphical user interface (GUI), a visual indicator 820 (e.g., a light emitting diode), and/or an audio transducer 825 (e.g., a speaker). In some aspects, the mobile computing device 800 incorporates a vibration transducer for providing the user with tactile feedback. In yet another aspect, the mobile computing device 800 incorporates input and/or output ports, such as an audio input (e.g., a microphone jack), an audio output (e.g., a headphone jack), and a video output (e.g., a HDMI port) for sending signals to or receiving signals from an external device.

FIG. 9 is a block diagram illustrating the architecture of one aspect of a mobile computing device. That is, the mobile computing device 900 can incorporate a system (e.g., an architecture) 902 to implement some aspects. In one embodiment, the system 902 is implemented as a “smart phone” capable of running one or more applications (e.g., browser, e-mail, calendaring, contact managers, messaging clients, games, and media clients/players). In some aspects, the system 902 is integrated as a computing device, such as an integrated personal digital assistant (PDA) and wireless phone.

One or more application programs 966 may be loaded into the memory 962 and run on or in association with the operating system 964. Examples of the application programs include phone dialer programs, e-mail programs, personal information management (PIM) programs, word processing programs, spreadsheet programs, Internet browser programs, messaging programs, and so forth. The system 902 also includes a non-volatile storage area 968 within the memory 962. The non-volatile storage area 968 may be used to store persistent information that should not be lost if the system 902 is powered down. The application programs 966 may use and store information in the non-volatile storage area 968, such as e-mail or other messages used by an e-mail application, and the like. A synchronization application (not shown) also resides on the system 902 and is programmed to interact with a corresponding synchronization application resident on a host computer to keep the information stored in the non-volatile storage area 968 synchronized with corresponding information stored at the host computer. As should be appreciated, other applications may be loaded into the memory 962 and run on the mobile computing device 900, including instructions for providing and operating an asset disposition engine.

The system 902 has a power supply 970, which may be implemented as one or more batteries. The power supply 970 might further include an external power source, such as an AC adapter or a powered docking cradle that supplements or recharges the batteries.

The system 902 may also include a radio interface layer 972 that performs the function of transmitting and receiving radio frequency communications. The radio interface layer 972 facilitates wireless connectivity between the system 902 and the “outside world,” via a communications carrier or service provider. Transmissions to and from the radio interface layer 972 are conducted under control of the operating system 964. In other words, communications received by the radio interface layer 972 may be disseminated to the application programs 966 via the operating system 964, and vice versa.

The visual indicator 820 may be used to provide visual notifications, and/or an audio interface 974 may be used for producing audible notifications via the audio transducer 825. In the illustrated embodiment, the visual indicator 820 is a light emitting diode (LED) and the audio transducer 825 is a speaker. These devices may be directly coupled to the power supply 970 so that when activated, they remain on for a duration dictated by the notification mechanism even though the processor 960 and other components might shut down for conserving battery power. The LED may be programmed to remain on indefinitely until the user takes action to indicate the powered-on status of the device. The audio interface 974 is used to provide audible signals to and receive audible signals from the user. For example, in addition to being coupled to the audio transducer 825, the audio interface 974 may also be coupled to a microphone to receive audible input, such as to facilitate a telephone conversation. In accordance with embodiments of the present disclosure, the microphone may also serve as an audio sensor to facilitate control of notifications, as will be described below. The system 902 may further include a video interface 976 that enables an operation of an on-board camera 830 to record still images, video stream, and the like.

A mobile computing device 900 implementing the system 902 may have additional features or functionality. For example, the mobile computing device 900 may also include additional data storage devices (removable and/or non-removable) such as, magnetic disks, optical disks, or tape. Such additional storage is illustrated in FIG. 9 by the non-volatile storage area 968.

Data/information generated or captured by the mobile computing device 900 and stored via the system 902 may be stored locally on the mobile computing device 900, as described above, or the data may be stored on any number of storage media that may be accessed by the device via the radio interface layer 972 or via a wired connection between the mobile computing device 900 and a separate computing device associated with the mobile computing device 900, for example, a server computer in a distributed computing network, such as the Internet. As should be appreciated such data/information may be accessed via the mobile computing device 900 via the radio interface layer 972 or via a distributed computing network. Similarly, such data/information may be readily transferred between computing devices for storage and use according to well-known data/information transfer and storage means, including electronic mail and collaborative data/information sharing systems.

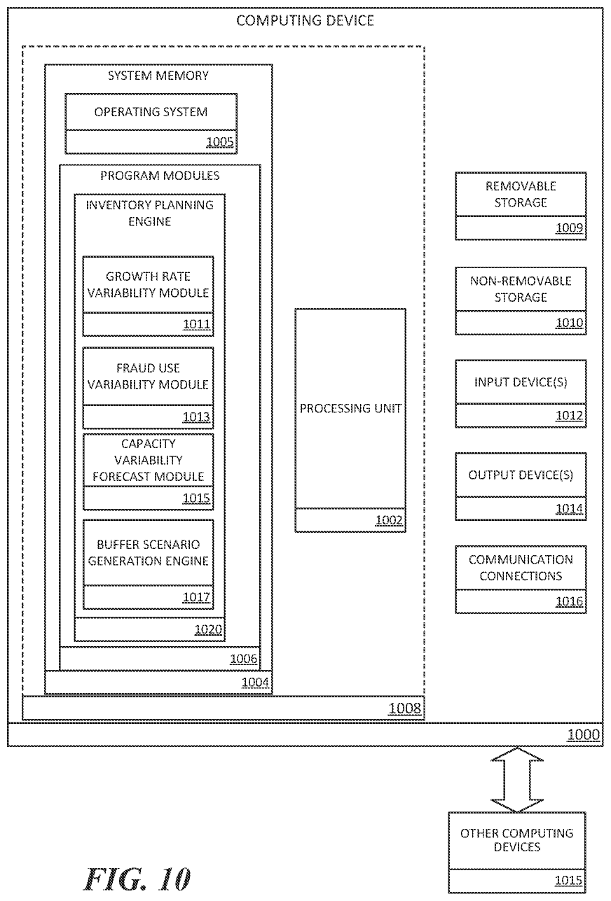

FIG. 10 is a block diagram illustrating physical components (e.g., hardware) of a computing device 1000 with which aspects of the disclosure may be practiced. The computing device components described below may have computer executable instructions for assisting with performing automated server ordering actions and generating server inventory insights in a multi-echelon cloud supply chain. In a basic configuration, the computing device 1000 may include at least one processing unit 1002 and a system memory 1004. Depending on the configuration and type of computing device, the system memory 1004 may comprise, but is not limited to, volatile storage (e.g., random access memory), non-volatile storage (e.g., read-only memory), flash memory, or any combination of such memories. The system memory 1004 may include an operating system 1005 suitable for running one or more asset disposition applications. The operating system 1005, for example, may be suitable for controlling the operation of the computing device 1000. Furthermore, embodiments of the disclosure may be practiced in conjunction with a graphics library, other operating systems, or any other application program and is not limited to any particular application or system. This basic configuration is illustrated in FIG. 10 by those components within a dashed line 1008. The computing device 1000 may have additional features or functionality. For example, the computing device 1000 may also include additional data storage devices (removable and/or non-removable) such as, for example, magnetic disks, optical disks, or tape. Such additional storage is illustrated in FIG. 10 by a removable storage device 1009 and a non-removable storage device 1010.

As stated above, a number of program modules and data files may be stored in the system memory 1004. While executing on the processing unit 1002, the program modules 1006 (e.g., inventory planning engine 1020) may perform processes including, but not limited to, the aspects, as described herein. According to examples, growth rate variability module 118 may perform operations associated with processing historical data center use data and generating demand growth projections based on that processing. Fraud use variability module 116 may perform operations associated with processing historical data center use data, determining an amount of that use that fraud accounted for, and generating fraud growth projections. Capacity variability forecast module 120 may perform operations associated with analyzing historical update information for a data center and generating sellable capacity projections for the data center. Buffer scenario generation engine 1017 may perform operations associated with determining ratios of safety stock that will meet service level targets, and determining which of those ratios is most cost-effective.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 10 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 1000 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 1000 may also have one or more input device(s) 1012 such as a keyboard, a mouse, a pen, a sound or voice input device, a touch or swipe input device, etc. The output device(s) 1014 such as a display, speakers, a printer, etc. may also be included. The aforementioned devices are examples and others may be used. The computing device 1000 may include one or more communication connections 1016 allowing communications with other computing devices 1050. Examples of suitable communication connections 1016 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1004, the removable storage device 1009, and the non-removable storage device 1010 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1000. Any such computer storage media may be part of the computing device 1000. Computer readable media and computer storage media as described herein does not include transitory media such as a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

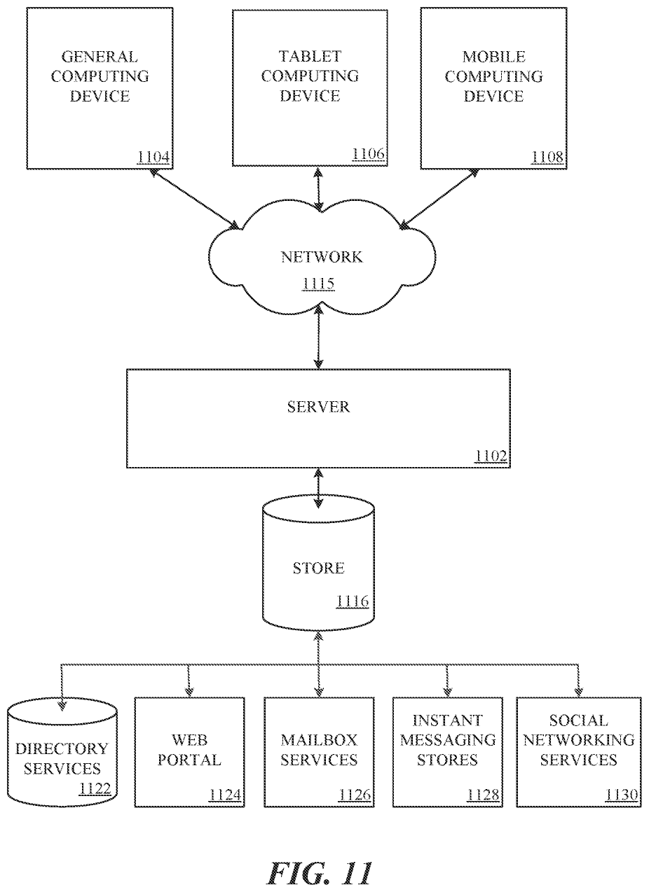

FIG. 11 illustrates one aspect of the architecture of a system for processing data received at a computing system from a remote source, such as a personal/general computer 1104, tablet computing device 1106, or mobile computing device 1108, as described above. Content displayed at server device 1102 may be stored in different communication channels or other storage types. For example, various documents may be stored using a directory service 1122, a web portal 1124, a mailbox service 1126, an instant messaging store 1128, or a social networking site 1130. The program modules 1006 may be employed by a client that communicates with server device 1102, and/or the program modules 1006 may be employed by server device 1102. The server device 1102 may provide data to and from a client computing device such as a personal/general computer 1104, a tablet computing device 1106 and/or a mobile computing device 1108 (e.g., a smart phone) through a network 1115. By way of example, the computer system described above may be embodied in a personal/general computer 1104, a tablet computing device 1106 and/or a mobile computing device 1108 (e.g., a smart phone). Any of these embodiments of the computing devices may obtain content from the store 1116, in addition to receiving graphical data useable to be either pre-processed at a graphic-originating system, or post-processed at a receiving computing system.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present disclosure, one skilled in the art may envision variations, modifications, and alternate aspects falling within the spirit of the broader aspects of the general inventive concept embodied in this application that do not depart from the broader scope of the claimed disclosure. The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A system for automating server orders, comprising:
a memory for storing executable program code; and
a processor, functionally coupled to the memory, the processor being responsive to computer-executable instructions contained in the program code and operative to:
determine an aggregate target service level for one or more data centers served by a server warehouse;
determine, for each of the one or more data centers, a number of server clusters needed to fulfill the aggregate target service level on a future date;
determine, for each of the one or more data centers for the future date, a first safety stock value corresponding to a first buffer number of server clusters needed to account for supply variability and demand variability for the one or more data centers based on a second safety stock value for the server warehouse corresponding to a second buffer number of server clusters in the server warehouse on the future date;
determine a first cost associated with implementing server clusters corresponding to the first safety stock value and the second safety stock value;
determine, for each of the one or more data centers for the future date, a third safety stock value corresponding to a third buffer number of server clusters needed to account for supply variability and demand variability for the one or more data centers based on a fourth safety stock value for the server warehouse corresponding to a fourth buffer number of server clusters in the server warehouse on the future date;
determine a second cost associated with implementing server clusters corresponding to the third safety stock value and the fourth safety stock value; and
automatically order server clusters, for each of the one or more data centers, corresponding to the third safety stock value based on the second cost being lower than the first cost.

2. The system of claim 1, wherein the processor is further responsive to the computer-executable instructions contained in the program code and operative to:
automatically order server clusters for the server warehouse corresponding to the fourth safety stock value based on the second cost being lower than the first cost.

3. The system of claim 1, wherein the third safety stock value is higher than the first safety stock value and the fourth safety stock value is lower than the second safety stock value.

4. The system of claim 1, wherein the number of server clusters needed to fulfill the aggregate service level for each of the one or more data centers for the future date has a built-in variability buffer.

5. The system of claim 4, wherein the processor is further responsive to the computer-executable instructions contained in the program code and operative to:
determine the variability buffer based on past virtual core computing workload execution data after hardware updates to corresponding server clusters have been completed.

6. The system of claim 4, wherein the processor is further responsive to the computer-executable instructions contained in the program code and operative to:
determine the variability buffer based on past virtual core computing workload execution data after software updates to corresponding server clusters have been completed.

7. The system of claim 1, wherein the processor is further responsive to the computer-executable instructions contained in the program code and operative to:
determine the supply variability for the one or more data centers based on calculating a lead time variability value between the server warehouse and each of the one or more data centers.

8. The system of claim 1, wherein the processor is further responsive to the computer-executable instructions contained in the program code and operative to:
determine the supply variability for the one or more data centers based on calculating a lead time variability value between one or more component locations and the server warehouse.

9. The system of claim 1, wherein the processor is further responsive to the computer-executable instructions contained in the program code and operative to:
determine the demand variability for the one or more data centers based on applying a statistical projection model to historical customer orders for the one or more data centers.

10. The system of claim 9, wherein the processor is further responsive to the computer-executable instructions contained in the program code and operative to:
determine the demand variability for the one or more data centers based on applying a statistical projection model to historical fraudulent use data for the one or more data centers.

11. A computer-implemented method for generating interactive data center insights, the computer-implemented method comprising:
determining an aggregate service level for one or more data centers served by a server warehouse;
determining, for each of the one or more data centers, a number of server clusters needed to fulfill the aggregate target service level on a future date;
determining, for each of the one or more data centers for the future data, a first safety stock value corresponding to a first buffer number of server clusters needed to account for supply variability and demand variability for the one or more data centers based on a second safety stock value for the server warehouse corresponding to a second buffer number of server clusters in the server warehouse on the future date;
determining a first cost associated with implementing server clusters corresponding to the first safety stock value and the second safety stock value;
determining, for each of the one or more data centers for the future date, a third safety stock value corresponding to a third buffer number of server clusters needed to account for supply variability and demand variability for the one or more data centers based on a fourth safety stock value for the server warehouse corresponding to a fourth buffer number of server clusters in the server warehouse on the future date;
determining a second cost associated with implementing server clusters corresponding to the third safety stock value and the fourth safety stock value;
determining that the second cost is at least a threshold value less than the first cost; and
causing, based on determining that the second cost is at least the threshold value less than the first cost, an interactive data center insight to be surfaced, wherein the interactive data center insight includes a selectable option to place an order, over a distributed computing network, for server clusters corresponding to the third safety stock value for each of the one or more data centers.

12. The computer-implemented method of claim 11, further comprising:
causing, based on determining that the second cost is at least the threshold value less than the first cost, the interactive data center insight to be surfaced with a selectable option to place a second order, over a distributed computing network, for server clusters corresponding to the fourth safety stock value for the server warehouse.

13. The computer-implemented method of claim 11, wherein the number of server clusters needed to fulfill the aggregate service level for each of the one or more data centers for the future date has a built-in variability buffer.

14. The computer-implemented method of claim 13, further comprising:
determining the variability buffer based on past virtual core computing workload execution data after hardware updates to corresponding server clusters have been completed.

15. The computer-implemented method of claim 13, further comprising:
determining the variability buffer based on past virtual core computing workload execution data after software updates to corresponding server clusters have been completed.

16. The computer-implemented method of claim 11, further comprising:
determining the supply variability for the one or more data centers based on calculating a lead time variability value between the server warehouse and each of the one or more data centers.

17. The computer-implemented method of claim 11, further comprising:
determining the supply variability for the one or more data centers based on calculating a lead time variability value between one or more component locations and the server warehouse.

18. The computer-implemented method of claim 11, further comprising:
determining the demand variability for the one or more data centers based on applying a statistical projection model to historical customer orders for the one or more data centers.

19. A computer-readable storage device comprising executable instructions that, when executed by a processor, assist with automating server orders, the computer-readable storage device including instructions executable by the processor for:
determining an aggregate target service level for a data center served by a server warehouse;
determining a first lead time metric by:
calculating a first mean lead time value between a component location and the server warehouse, and
calculating a first lead time variability value between the component location and the server warehouse;
determining a second lead time metric by:
calculating a second mean lead time value between the server warehouse and the data center, and
calculating a second lead time variability value between the server warehouse and the data center;
determining a mean cloud demand value for a future date at the data center;
determining a variability metric for the mean cloud demand value for the future date at the data center;
determining, for the future date at the data center, a sellable capacity variability metric corresponding to fluctuation in a number compute units available in servers of the data center;
determining a safety stock distribution having a smallest cost associated with it, the safety stock distribution corresponding to a buffer number of server clusters to be kept in the data center, at the server warehouse, and at the component location, to account for the first lead time metric, the second lead time metric, the mean cloud demand value, the variability metric, the sellable capacity variability metric, and the aggregate target service level for the data center; and
automatically ordering server clusters to satisfy the safety stock distribution.

20. The computer-readable storage device of claim 19, wherein determining the mean cloud demand value for the future date at the data center comprises:
determining a cloud demand growth rate associated with the data center.
